(19) United States
(12) Patent Application Publication
(10) Pub. No.: US 2008/0126625 A1
(43) Pub. Date: May 29, 2008

(54) JUST-IN-TIME BUFFER ALLOCATION FOR USE IN EVENT COMPLETION STYLE INPUT/OUTPUT MODELS

(75) Inventors: David Blair Gilgen, Raleigh, NC (US); William Daniel Wigger, Durham, NC (US)

Correspondence Address: GERALD J. IWANEJKO, JR., 229 HICKORY HILL DRIVE, VOLANT, PA, 16156, US

(73) Assignee: INTERNATIONAL BUSINESS MACHINES CORPORATION, Armonk, NY (US)

(21) Appl. No.: 11/458,004

(22) Filed: Jul. 17, 2006

(51) Int. Cl. G06F 13/00

(52) U.S. Cl. 710/56

(57) ABSTRACT

An invention is disclosed for improved computer system or network efficiency in use of “just-in-time” (JIT) buffer allocation for “event completion” style input/output (I/O) models. Specifically, a method and system are disclosed for use of JIT programming techniques to overcome excessive memory usage and performance problems caused by large numbers of buffer allocations during completion of I/O events, through the use of buffers allocated “just-in-time” when I/O events are ready to be processed instead of at the time when the I/O request is initially made, in order to allow buffers allocated prior to (or at the time of) an initial I/O request to be released for other uses if they are not needed immediately to complete the requested I/O event.

### TECHNICAL FIELD

This invention relates generally to use of “event completion” style input/output (I/O) models in computer system or network applications, and specifically to a method and system for use of JIT programming techniques to allocate buffers “just-in-time” when I/O events are ready to be processed instead of at the time when the I/O request is initially made.

### BACKGROUND

The rapid advancement in the availability of computers has led to the development of different types of operating systems (OS) to run various computer system or network components under the processing instructions of application software programs requiring use of those components. Under this scheme, computer components are used to perform processing functions on data under the control of system or network OS instructions, when these functions are directly or indirectly invoked (such as through middleware) by an application to produce a desired result according to the needs of a computer user. Such operating systems include IBM-compatible computers running Windows® system or network applications, Apple® machines running their own operating system(s), or various machines running Unix® operating systems.

In order to accomplish such processing operations, the computer system or network must provide a means for the orderly and efficient access and transfer of data and instructions using input/output (I/O) operations, which are also carried out under the control of operating system(s) when invoked by application program(s) to accomplish a desired task. I/O operations encompass all types of actions and communications between a computer and its users and/or its processing, storage or peripheral devices, as well as with other system computers (via a network such as a local area network (“LAN”) or a wide area network (“WAN”) or the Internet using a communications protocol such as Transmission Control Protocol over Internet Protocol (TCP/IP)) or the outside world; including “read” operations (where information is extracted from a stored location in a system or network device) as well as “write” operations (where information is stored in a system or network location) and “transfer” operations (where information is transmitted from one system or network location or device to another).

The amount of computer system memory available to perform such I/O operations usually varies depending on the system used and includes “buffer” space, i.e., temporary memory space allocated to the I/O operation in an intermediate processing step for internally storing data or instruction(s) pending further use. The buffer memory is usually set aside prior to execution of the I/O operation but this presents certain disadvantages in system performance, particularly when carrying out I/O operations on a dynamic (changing as-needed) basis between networked computers acting under the control of different operating system platforms. Additionally, the amount of buffer memory allocated to I/O operations may be less than the total amount required for program execution, and execution of further I/O operations is adversely affected if a large amount of the budgeted memory available for buffer allocation is in use. To solve these problems, “just-in-time” (JIT) programming methods (including those involving the Java programming language) can be used to provide flexible dynamic buffer allocation during execution (or “runtime”) of the I/O operation, instead of prior thereto as with current I/O buffering techniques. Examples of such JIT programming methods are described in the teachings set forth in U.S. Pat. Nos. 6,901,587 & 6,658,652 and in U.S. Patent Application Publication No. 2003/0131147 (the disclosures of which are all incorporated by reference as if fully set forth herein); and in “A Brief History of Just-In-Time” authored by John Aycock and in “Dynamic Metrics for Java” by Bruno Dufour, Karel Driesen, Laurie Hendren and Clark Verbrugge (the teachings of which are also all incorporated by reference as if fully set forth herein).

Significant improvements can be made in I/O operations through system optimization using JIT buffer allocation techniques, including a reduction in memory consumption in order to increase the speed of program operation. However, existing prior art solutions do not contemplate such techniques to adequately maximize the efficiency of use of buffer memory allocated to I/O operations. The present invention seeks to solve this problem through use of “just-in-time” (JIT) buffer allocation for “event completion” style input/output (I/O) models.

### SUMMARY OF THE INVENTION

An invention is disclosed for improved computer system or network efficiency in use of “just-in-time” (JIT) buffer allocation for “event completion” style input/output (I/O) models. Specifically, a method and system are disclosed for use of JIT programming techniques to overcome excessive memory usage and performance problems caused by large numbers of buffer allocations during completion of I/O events, through the use of buffers allocated “just-in-time” when I/O events are ready to be processed instead of at the time when the I/O request is initially made, in order to allow buffers allocated prior to (or at the time of) an initial I/O request to be released for other uses if they are not needed immediately to complete the requested I/O event.

A preferred implementation of the invention requires programming modification of the “user code” and “event completion code” used to execute “event completion” style I/O requests, involving changes to the application programming interface (API) between the two as follows:

(1). An “I/O request interface” calling for execution of a “read” (or other) I/O operation by the event completion code continues to require allocation of a socket reference and one or more buffer address(es) by the user code when it initiates the I/O request. However, the I/O request interface is modified to also require a new indicator (referred to as a “JIT indicator flag”) to be set by the user code to indicate whether or not other buffer address(es) can be allocated later if the socket “read” operation cannot be started (i.e., no information can be read) upon initial receipt of the I/O request.
(2). A “wait-for-completion interface” is modified to allow zero, one or more new buffer address(es) (referred to as a “JIT buffer”) to be designated if the user code makes a call to the event completion code with an instruction to await completion of the next I/O event when allocating a buffer. A “return value” is also added to indicate to the user code whether or not the JIT buffer(s) were used to store the accessed data or instructions in completing the I/O request, or if the buffer(s) originally designated upon initiation of the I/O request were used instead.

If a user code instructs an event completion code to await the next I/O event using the “wait-for-completion interface”, it will do so by indicating that (one or more) optional JIT buffer(s) can be used by the event completion code to execute that event. Additionally, when more than one size for buffers is available and can be used to complete a particular I/O request, the size(s) required for a particular I/O event can be indicated upon initiation of the I/O request, and the value(s) can be stored for later reference if the request is not completed immediately. A set of different sized buffers can then be designated on all “wait-for-completion” calls, and the event completion code can select the required buffer size(s) upon execution of the request.

It is therefore an object of the present invention to overcome the disadvantages of the prior art by providing improved use of “event completion” style input/output (I/O) models in computer system or network applications, through disclosure of a method and system for allocating buffers “just-in-time” when I/O events are ready to be processed instead of at the time when the I/O request is initially made, in order to allow buffers allocated prior to (or at the time of) an initial I/O request to be released for other uses if they are not needed immediately to complete the requested I/O event.

It is another object of the present invention to overcome the disadvantages of the prior art by providing improved computer system or network efficiency in use of “just-in-time” (JIT) buffer allocation for “event completion” style input/output (I/O) models, through disclosure of a method and system for use of an “I/O request interface” calling for execution of a “read” (or other) I/O operation by an event completion code_through allocation of a socket reference and one or more buffer address(es) by a user code when it initiates the I/O request, and also providing an indicator (referred to as a “JIT indicator flag”) set by the user code to indicate whether or not other buffer address(es) can be allocated later if the socket cannot be accessed (i.e., no information can be read) upon initial receipt of the I/O request

It is another object of the present invention to overcome the disadvantages of the prior art by providing improved computer system or network efficiency in use of “just-in-time” (JIT) buffer allocation for “event completion” style input/output (I/O) models, through disclosure of a method and system for use of a “wait-for-completion interface” allowing zero, one or more new buffer address(es) (referred to as a “JIT buffer”) to be designated if the user code makes a call to the event completion code with an instruction to await completion of the next I/O event when allocating a buffer, and also providing a “return value” to indicate to the user code whether or not the JIT buffer(s) were used to complete the I/O request, or if the buffer(s) originally designated upon initiation of the I/O request were used instead.

It is another object of the present invention to overcome the disadvantages of the prior art by providing improved computer system or network efficiency in use of “just-in-time” (JIT) buffer allocation for “event completion” style input/output (I/O) models, through disclosure of a method and system for use of more than one size for buffers in completing a particular I/O request, where the size(s) required for a particular I/O event are indicated upon initiation of the I/O request and the value(s) are stored for later reference if the request is not completed immediately, so that the event completion code selects the required buffer size(s) upon execution of the request.

The subject matter which is regarded as the invention is particularly pointed out and distinctly claimed in the concluding portion of the specification. The invention, however, together with further objects and advantages thereof, may best be understood by reference to the following description taken in conjunction with the accompanying drawings.

### BRIEF DESCRIPTION OF THE DETAILED DRAWINGS

FIG. 1 is a diagram illustrating a prior art “event completion” style input/output (I/O) model.

FIG. 2 is a diagram illustrating the components of the invention used to perform “just-in-time” (JIT) buffer allocation for “event completion” style input/output (I/O) computer models.

### DETAILED DESCRIPTION OF THE PREFERRED EMBODIMENTS

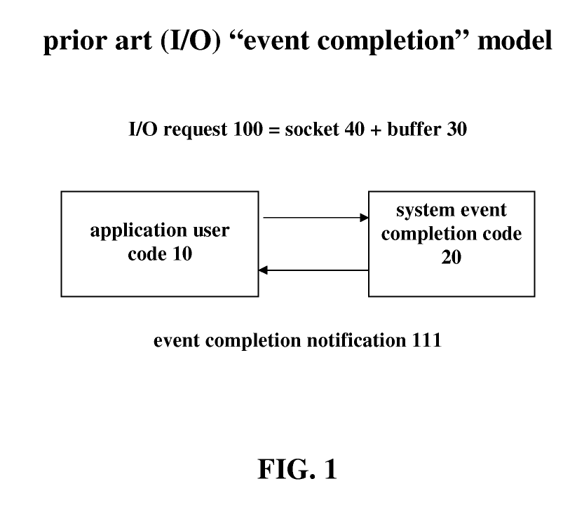

As illustrated in FIG. 1, input/output (I/O) “event completion” models are based upon use of application programming interfaces (APIs) that allow a software application to communicate with a computer operating system for the purpose of requesting performance of a particular I/O operation. When such I/O operations take place over a computer system or network, I/O “read” (or other) requests are made by a “user code” of the requesting application 10 in order to send (or retrieve) data or instructions for the purpose of transmitting them from one system or network location or device to another. The user code 10 initiates an I/O request 100 by passing a “socket” reference 40 (providing the system or network communications address(es) used to establish a connection with the location(s) and/or device(s) to be accessed) along with one or more allocated memory “buffer” address(es) 30 (designated for temporarily storing the accessed data or instructions pending further use) to an “event completion code” module 20.

If the socket 40 is ready to be accessed at the time of the I/O request 100, the needed data or instructions will be immediately returned in the designated buffer address(es) 30 for further processing by the user code 10, as the request is satisfied by the event completion code 20. If the socket 40 is not ready to be accessed at the time of the request, the event completion code 20 will store the designated buffer address(es) 30 for later use when the socket 40 does become available, at which point the accessed data or instructions will be input into those buffer(s). If one or more I/O operations 100 are outstanding, the user code 10 can then query the event completion code 20 to get notification 111 of completion of any one of the outstanding I/O operations. However, this technique presents a problem if a large number of socket connections are needed since buffers must be allocated for every such I/O operation, which can add up to large memory usage requirements and also cause other system performance problems.

The invention overcomes these problems through use of “just-in-time” (JIT) buffer allocation for “event completion” style input/output (I/O) models in situations where designated buffers are “idle”, i.e., waiting for data or instructions to be input into them. This is accomplished through use of standard JIT programming techniques to allocate buffers “just-in-time” when I/O events are ready to be processed during program runtime instead of at the time when the I/O request is initially made, in order to allow buffers allocated prior to (or at the time of) an initial I/O request to be released for other uses if they are not needed immediately to complete the requested I/O event.

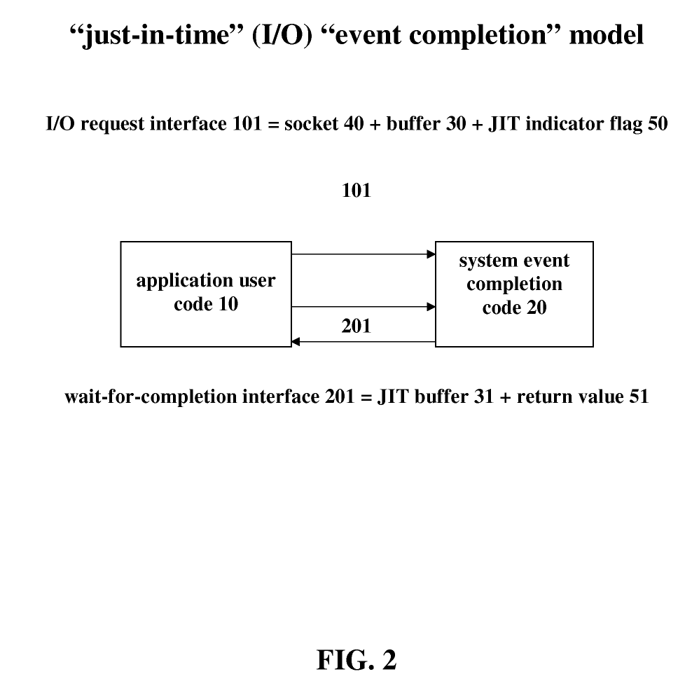

As illustrated in FIG. 2, a preferred implementation of the invention requires programming modification of the “user code” 10 and “event completion code” 20 normally used to execute “event completion” style I/O requests, involving changes to the API between the two as follows:

(1). The “I/O request interface” 101 calling for execution of a “read” (or other) I/O operation by the event completion code 20 continues to require allocation of a socket reference 40 and one or more buffer address(es) 30 by the user code 10 when it initiates the I/O request. However, the I/O request interface 101 is modified to also require a new indicator (referred to as a “JIT indicator flag” 50) to be set by the user code 10 to indicate whether or not other buffer address(es) can be allocated later if the socket 40 “read” operation cannot be started (i.e., no information can be read) since it need not be accessed upon initial receipt of the I/O request.
(2). A “wait-for-completion interface” 201 is modified to allow zero, one or more new buffer address(es) (referred to as a “JIT buffer” 31) to be designated if the user code 10 makes a call to the event completion code 20 with an instruction to await completion of the next I/O event when allocating a buffer (by using a JIT allocated buffer 31). A “return value” 51 is also added to indicate to the user code 10 whether or not the JIT buffer(s) 31 were used to store the accessed data or instructions, or if the buffer(s) 30 originally designated upon initiation of the I/O request were used instead

When a user code 10 calls an event completion code 20 using the I/O request interface 101 of the invention to initiate an I/O event, it will allocate a socket 40 and designate the address(es) of the buffer(s) 30 in which it prefers the needed data or instructions to be stored, and it will also set the JIT indicator flag 50 (if the buffer is empty and a standard size) to indicate that one or more buffer(s) can be allocated later if the I/O request is not completed upon its initiation. Upon receiving the I/O request, the event completion code 20 will determine whether the socket 40 is ready to be accessed, and if so, the retrieved data or instructions will be input into the designated buffer address(es) 30. If the socket 40 is not ready to be accessed upon receipt of the I/O request, the event completion code 20 will either save the designated buffer address(es) 30 (to be retrieved later when the socket 40 is ready for use) or will discard them, depending on whether the JIT indicator flag 50 is set. (If so, then the buffer address(es) will be discarded and vice versa if the flag is not set).

Upon receipt of a response on the status of the I/O request from the event completion code 20, the user code 10 can free (or return to a pool or reuse) the originally designated buffer(s) 30 if they were not used to complete the I/O request upon initiation (provided that the JIT indicator flag 50 is set) since the request can be subsequently completed using JIT buffer(s) 31 allocated at a later time when the socket 40 is ready for use. If a user code 10 instructs an event completion code 20 to await the next I/O event 100 using the “wait-for-completion interface” 201, it will do so by indicating that (one or more) JIT buffer(s) 31 (which can also be reused or obtained from a pool) can optionally be used by the event completion code 20 to execute that event. Since the user code 10 has no indication of which I/O request 100 will be completed by the event completion code 20 when a request is made, JIT buffer(s) 31 are prepared in the event that the completed request is one that requires JIT buffer(s). Therefore, use of the word “optional” in this context means that the event completion code 20 should use JIT buffer(s) 31 if completing an I/O request 100 which requires them, while also meaning that the event completion code 20 will not use JIT buffer(s) 31 if it is completing an I/O request 100 that does not require them. Upon receiving an instruction to await the next I/O event, the event completion code 20 will determine the next socket 40 that is ready to be accessed (which may be any one of a large number of sockets that were requested for use in an I/O event). When a socket 40 is ready to be accessed, the event completion code 20 will determine if the buffer(s) 30 originally designated in the initial I/O request should be used, or if JIT buffer(s) 31 should be used instead to execute the I/O operation, again depending on whether the JIT indicator flag 50 is set. (If so then JIT buffer(s) 31 will be used, and if the flag is not set then the original buffer(s) 30 will be used). The event completion code 20 will then set a return value 51 for the JIT indicator flag to reveal whether or not JIT buffer(s) 31 were used to complete the I/O operation. Finally, the user code 10 will release (or reuse) the JIT buffer(s) 31 if they were not used.

There are some cases where the user code will not permit JIT buffers to be used on I/O requests, such as when a partially filled buffer is being used by contiguously entered data, or where a non-standard size buffer is being used. In these cases, the JIT supported indicator will not be set upon initiation of the I/O request, and the originally designated buffer(s) will continue to be needed by the event completion code until the I/O request is completed. Additionally, when more than one size for buffers is available and can be used to complete a particular I/O request, the size(s) required for a particular I/O event can be indicated upon initiation of the I/O request, and the value(s) can be stored for later reference if the request is not completed immediately. A set of different sized buffers can then be designated on all “wait-for-completion” calls, and the event completion code can select the required buffer size(s) upon execution of the request. In most cases, however, use of a standard size empty buffer should permit “just-in-time” (JIT) buffer allocation as described herein, allowing maximum memory usage efficiency and other performance benefits.

While certain preferred features of the invention have been shown by way of illustration, many modifications and changes can be made that fall within the true spirit of the invention as embodied in the following claims, which are to be interpreted as broadly as the law permits to cover the full scope of the invention, including all equivalents thereto.

What is claimed is:

1. A computer system or network for executing completion of input/output (I/O) events and comprised of at least the following software components:
(a). an I/O request interface called by an application user code to initiate an I/O request for execution by a system event completion code through:
(i). allocation of a communications socket and at least one memory buffer address; and
(ii). designation of an indicator set by the user code to identify whether one or more other buffer addresses can be allocated later if the socket cannot be accessed upon receipt of the I/O request; and
(b). a wait-for-completion interface providing:
(i). an indication for use of a new buffer address when the user code makes a call to the event completion code with an instruction to await completion of the next I/O event when allocating a buffer; and
(ii). a return value to indicate whether one or more new buffers were used to complete the I/O request or if those buffers originally designated upon initiation of the I/O request were used instead;
wherein any buffers allocated prior to or at the time of an I/O request are released for other uses if not needed to complete the requested I/O event.

2. The computer system or network of claim 1 wherein at least one memory buffer is allocated at the time when an I/O event is processed instead of at the time when an I/O request is made.

3. The computer system or network of claim 2 wherein buffers of more than one size are used in completing an I/O request such that the buffer sizes required for an I/O event are indicated upon initiation of the I/O request and the values are stored if the I/O request is not completed immediately so that the event completion code selects the required buffer sizes upon execution of the I/O request.

4. The computer system or network of claim 1 wherein at least one I/O event is comprised of a read operation executed between different system or network locations or devices.

5. The computer system or network of claim 4 wherein at least one I/O event is executed using Transmission Control Protocol over Internet Protocol (TCP/IP) for socket communications.

6. The computer system or network of claim 5 wherein the software components execute completion of at least one I/O event using the Java programming language.

7. A method of using a computer system or network for executing completion of input/output (I/O) events by performing a procedure comprised of the following steps:
(a). using an I/O request interface called by an application user code to initiate an I/O request for execution by a system event completion code through:
(i). allocating a communications socket and at least one memory buffer address; and
(ii). designating an indicator set by the user code to identify whether one or more other buffer addresses can be allocated later if the socket cannot be accessed upon receipt of the I/O request; and
(b). using a wait-for-completion interface for providing:
(i). an indication for use of a new buffer address when the user code makes a call to the event completion code with an instruction to await completion of the next I/O event when allocating a buffer; and
(ii). a return value to indicate whether one or more new buffers were used to complete the I/O request or if those buffers originally designated upon initiation of the I/O request were used instead;
wherein any buffers allocated prior to or at the time of an I/O request are released for other uses if not needed to complete the requested I/O event.

8. The method of claim 7 wherein at least one memory buffer is allocated at the time when an I/O event is processed instead of at the time when an I/O request is made.

9. The method of claim 8 wherein buffers of more than one size are used in completing an I/O request such that the buffer sizes required for an I/O event are indicated upon initiation of the I/O request and the values are stored if the I/O request is not completed immediately so that the event completion code selects the required buffer sizes upon execution of the I/O request.

10. The method of claim 7 wherein at least one I/O event is comprised of a read operation executed between different system or network locations or devices.

11. The method of claim 10 wherein at least one I/O event is executed using Transmission Control Protocol over Internet Protocol (TCP/IP) for socket communications.

12. The method of claim 11 wherein the software components execute completion of at least one I/O event using the Java programming language.
